(19) United States
(12) Patent Application Publication
(10) Pub. No.: US 2008/0117377 A1
(43) Pub. Date: May 22, 2008

(54) Liquid crystal display with protrusions formed at non-display area of liquid crystal display panel thereof

(75) Inventors: Chia-Ming Chan, Miao-Li (TW); Hung-Sheng Cho, Miao-Li (TW); Kun-Hsing Hsiao, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/985,890

(22) Filed: Nov. 19, 2007

(30) Foreign Application Priority Data
Nov. 17, 2006 (CN) 200610156916.1

(51) Int. Cl. G02F 1/1339

(52) U.S. Cl. 349/153

(57) ABSTRACT

An exemplary liquid crystal display (2) includes a liquid crystal display panel (20) defining a display area and a non-display. The liquid crystal display panel includes a first substrate (21), a second substrate (23), a sealing member (25) located at peripheral sides of the non-display area of the second substrate, and a liquid crystal layer (27). The first substrate includes first protrusions (214) located at the non-display area adjacent to the sealing member. The second substrate includes second protrusions (234) located at the non-display area adjacent to the sealing member. The first protrusions protrude toward the second substrate and the second protrusions protrude toward the first substrate. The first protrusions are alternately arranged relative to the second protrusions.

### FIELD OF THE INVENTION

The present invention relates to liquid crystal displays (LCDs), and more particularly to a liquid crystal display with protrusions formed at a non-display area of a liquid crystal display panel employed in the liquid crystal display.

### GENERAL BACKGROUND

Liquid crystal displays have the advantages of portability, low power consumption, and low radiation. Therefore, liquid crystal displays have been widely used in common daily life. Typically, a liquid crystal display includes a liquid crystal display panel.

FIG. 9 is an exploded, isometric view of a conventional liquid crystal display panel 10. The liquid crystal display panel 10 includes a color filter substrate 11, a thin film transistor (TFT) substrate 13 disposed generally parallel to the color filter substrate 11, a peripheral sealant 15 located at the TFT substrate 13, and a liquid crystal layer 17 arranged between the color filter substrate 11 and the TFT substrate 13. The sealant 15 may be an ultraviolet light hardened-type sealant or a thermally hardened sealant.

The sealant 15 is sandwiched between the color filter substrate 11 and the TFT substrate 13. The sealant 15 coupled with the TFT substrate 13 and the color filter substrate 11 defines a liquid crystal cell (not labeled). The liquid crystal layer 17 is sealed in the liquid crystal cell.

The liquid crystal display panel 10 may be assembled by the following steps. Firstly, the TFT substrate 13 is provided. Secondly, the unhardened sealant 15 is arranged at four peripheral sides of the TFT substrate 13 to form a four-sided frame pattern. The sealant 15 together with the TFT substrate 13 forms a space for holding liquid crystal. Afterward, liquid crystal is put into the space drop by drop. The space is thereby filled with the liquid crystal. Then the TFT substrate 13 is transferred to a vacuum chamber. The color filter substrate 11 is pressed onto the sealant 15 and thereby covers the TFT substrate 13. Finally, the sealant 15 is hardened so as to bond the color filter substrate 11 and the TFT substrate 13 together.

Referring also to FIG. 10, this is a side cross-sectional view of an end portion of the assembled liquid crystal display panel 10 after the liquid crystal display panel 10 has been assembled. Typically, the color filter substrate 11 includes a black matrix 14 and a coating layer 12 covered on the black matrix 14. The black matrix 14 and the coating layer 12 protrude toward the TFT substrate 13.

During the process of manufacturing the liquid crystal display panel 10, the color filter substrate 11 is pressed onto the TFT substrate 13 before the sealant 15 is hardened. The black matrix 14 and the coating layer 12 of the color filter substrate 11 may protrude into the liquid crystal layer 17 and extrude some liquid crystal toward the unhardened sealant 15. The unhardened sealant 15 is liable to be deformed by impact force exerted by the extruding liquid crystal. In particular, grooves 16 may be formed at parts of the sealant 15 that are adjacent to the TFT and color filter substrates 13, 11. As a result, the contacting areas between the sealant 15 and the TFT and color filter substrates 13, 11 are reduced. That is, the color filter and TFT substrates 11, 13 may not be strongly combined together with the sealant 15. Therefore, when the liquid crystal display panel 10 sustains shock or vibration, the color filter substrate 11 is liable to detach from the TFT substrate 13. When the liquid crystal display panel 10 becomes damaged in this way, it may malfunction or even fail altogether.

What is needed, therefore, is a liquid crystal display employing a liquid crystal display panel that can overcome the above-described deficiencies.

### SUMMARY

In one aspect, a liquid crystal display includes a liquid crystal display panel defining a display area, and a non-display area around the display area. The liquid crystal display panel includes a first substrate, a second substrate parallel to the first substrate, a sealing member located at peripheral sides of the non-display area of the second substrate, and a liquid crystal layer. The sealing member coupled with the first and second substrates defines a liquid crystal cell. The liquid crystal layer is contained in the liquid crystal cell. The first substrate includes a plurality of first protrusions located at the non-display area adjacent to the sealing member. The second substrate includes a plurality of second protrusions located at the non-display area adjacent to the sealing member. The first protrusions protrude toward the second substrate and the second protrusions protrude toward the first substrate. The first protrusions are alternately arranged relative to the second protrusions.

In another aspect, a liquid crystal display includes a liquid crystal display panel defining a display area, and a non-display area around the display area. The liquid crystal display panel includes a first substrate, a second substrate parallel to the first substrate, a sealing member located at peripheral sides of the non-display area of the second substrate, and a liquid crystal layer. The sealing member coupled with the first and second substrates defines a liquid crystal cell. The liquid crystal layer is contained in the liquid crystal cell. The first substrate includes a plurality of first protrusions located at the non-display area adjacent to the sealing member. The second substrate includes a plurality of second protrusions located at the non-display area adjacent to the sealing member. The first protrusions protrude toward the second substrate and the second protrusions protrude toward the first substrate. The plurality of first protrusions are staggered relative to at least a plurality of the second protrusions.

Other novel features and advantages will become more apparent from the following detailed description when taken in conjunction with the accompanying drawings. In the drawings, all the views are schematic.

### BRIEF DESCRIPTION OF THE DRAWINGS

FIG. 1 is a side cross-sectional view of an end portion of a liquid crystal display according to a first embodiment of the present invention.

FIG. 2 is a side cross-sectional view of an end portion of a liquid crystal display panel according to a second embodiment of the present invention.

FIG. 3 is a top plan view of a second substrate of a liquid crystal display panel according to a third embodiment of the present invention.

FIG. 4 is a bottom view plan of a first substrate of the liquid crystal display panel of the third embodiment of the present invention.

FIG. 5 is a top plan view of part of a second substrate of a liquid crystal display panel according to a fourth embodiment of the present invention.

FIG. 6 is a bottom plan view of part of a first substrate of the liquid crystal display panel according to the fourth embodiment of the present invention.

FIG. 7 is a top plan view of part of a second substrate of a liquid crystal display panel according to a fifth embodiment of the present invention.

FIG. 8 is a bottom plan view of part of a first substrate of the liquid crystal display panel according to the fifth embodiment of the present invention.

FIG. 9 is an exploded, isometric view of a conventional liquid crystal display panel.

FIG. 10 is a side cross-sectional view of an end portion of the liquid crystal display panel of FIG. 9 after the liquid crystal display panel has been assembled.

### DETAILED DESCRIPTION OF PREFERRED EMBODIMENTS

Reference will now be made to the drawings to describe the preferred and exemplary embodiments in detail.

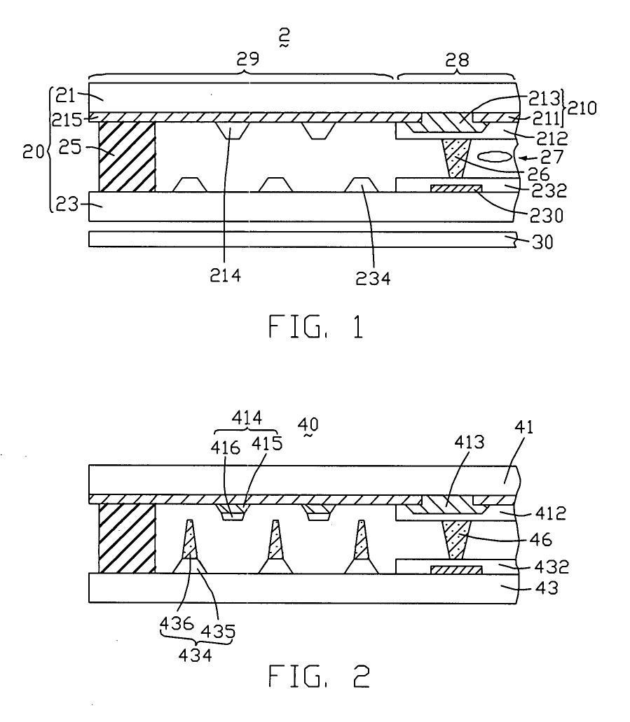

FIG. 1 is a side cross-sectional view of an end portion of a liquid crystal display 2 according to a first embodiment of the present invention. The liquid crystal display 2 includes a liquid crystal display panel 20, and a backlight module 30 disposed under the liquid crystal display panel 20. The backlight module 30 provides flat and uniform light for illuminating the liquid crystal display panel 20. The liquid crystal display panel 20 defines a display area 28 at a central portion thereof (only a small part of which is shown), and a peripheral non-display area 29 around the central display area 28.

The liquid crystal display panel 20 includes a first substrate 21, a second substrate 23 disposed parallel to the first substrate 21, a sealant 25 located at four peripheral sides of the non-display area 29 of the second substrate 23, a plurality of spacers 26 disposed between the first and second substrates 21, 23, and a liquid crystal layer 27. In the illustrated embodiment, the first substrate 21 is a color filter substrate, and the second substrate 23 is a TFT substrate. The distance between the first substrate 21 and the second substrate 23 is about 4˜6 micrometers.

The sealant 25 coupled with the first substrate 21 and the second substrate 23 defines a liquid crystal cell (not labeled). The liquid crystal layer 27 is sealed in the liquid crystal cell. The spacers 26 are located in the display area 28 between the first and second substrates 21, 23.

The first substrate 21 includes a color filter layer 210, a first coating layer 212 covering the color filter layer 210, and a light shield layer 215. The color filter layer 210 is located in the display area 28 of the first substrate 21. The color filter layer 210 includes a plurality of color filter units 211 and a black matrix 213. The black matrix 213 fills gaps between the color filter units 211.

The light shield layer 215 is located in the non-display area 29 of the first substrate 21. The light shield layer 215 is provided to absorb light beams at the non-display area 29. The light shield layer 215 is made of the same material as the black matrix 213, and is simultaneously formed with the black matrix 213 in a same fabricating step.

The light shield layer 215 includes a plurality of first protrusions 214 separately arranged thereon. The first protrusions 214 are located between the display area 28 and the sealant 25. The first protrusions 214 are made of the same material as the first coating layer 212, and are simultaneously formed with the first coating layer 212 in a same fabricating step. Each of the first protrusions 214 has a trapezoidal cross-section. In the illustrated embodiment, the trapezoidal cross-section is an isosceles trapezoid. That is, each first protrusion 214 has a width that progressively decreases with increasing distance away from the first substrate 21. The maximum width of the first protrusion 214 is preferably in a range up to 200 micrometers. The minimum width of the first protrusion 214 is preferably in a range down to 20 micrometers. Each of the first protrusions 214 typically has a height in the range from 1.5 micrometers to 2.5 micrometers. The first protrusions 214 can for example be frusto-conical, frusto-pyramidal, frusto-polyhedral, or dome-shaped.

The second substrate 23 includes a plurality of TFTs 230, a second coating layer 232 covering the TFTs 230, and a plurality of second protrusions 234. The TFTs 230 are located on the second substrate 23 directly under corresponding portions of the black matrix 213. Each of the spacers 26 is located between a respective one of the TFTs 230 and the corresponding portion of the black matrix 213. Each of the second protrusions 234 has a structure similar to that of each of the first protrusions 214. The second protrusions 234 are located in the non-display area 29 of the second substrate 23, between the display area 28 and the sealant 25. The second protrusions 234 are made of the same material as the second coating layer 232, and are simultaneously formed with the second coating layer 232 in a same fabricating step. The second and first protrusions 234, 214 are alternately arranged relative to each other. In the illustrated embodiment, the second and first protrusions 234, 214 are aligned along a same vertical plane along a direction from the display area 28 to the sealant 25, but are staggered relative to each other. In alternative embodiments, the second protrusions 234 can be aligned along a same vertical plane, and the first protrusions 214 can be aligned along a same vertical plane different from the vertical plane of the second protrusions 234.

The liquid crystal display panel 20 may be assembled by the following steps. Firstly, the second substrate 23 is provided. Secondly, the unhardened sealant 25 is arranged at four peripheral sides of the second substrate 23 to form a four-sided frame pattern. The sealant 25 together with the second substrate 23 forms a space for holding liquid crystal. Afterward, liquid crystal is put into the space drop by drop. The space is thereby filled with liquid crystal. Then the second substrate 23 is transferred to a vacuum chamber. The first substrate 21 is pressed onto the sealant 25 and thereby covers the second substrate 23. Finally, the sealant 25 is hardened so as to bond the first and second substrates 21, 23 together.

The first and second substrates 21, 23 include the plurality of first and second protrusions 214, 234 located in the non-display area 29 between the display area 28 and the sealant 25. During the process of manufacturing the liquid crystal display panel 20, the first substrate 21 is pressed onto the second substrate 23 before the sealant 25 is hardened. The black matrix 213 and the first coating layer 212 of the first substrate 21 protrude into the liquid crystal layer 27 and extrude some of the liquid crystal toward the unhardened sealant 25. However, the first and second protrusions 214, 234 block the movement of the liquid crystal. Therefore little or even no force is exerted on the unhardened sealant 25 by the extruding liquid crystal. That is, the unhardened sealant 25 sustains little or even no deformation. The contacting areas between the sealant 25 and the first and second substrates 21, 23 remain substantially unchanged. Thus the first and second substrates 21, 23 are strongly bonded together with the sealant 25. As a result, even if the liquid crystal display 2 sustains shock or vibration, damage to the liquid crystal display panel 20 is avoided.

FIG. 2 is a side cross-sectional view of an end portion of a liquid crystal display panel 40 according to a second embodiment of the present invention. The liquid crystal display panel 40 has a structure similar to that of the liquid crystal display panel 20. However, a first substrate 41 includes a plurality of first protrusions 414 at a non-display area (not labeled) thereof. Each of the first protrusions 414 includes a first portion 415, and a second portion 416 extending from the first portion 415. A black matrix 413 and a first coating layer 412 are provided in a display area (not labeled) of the liquid crystal display panel 40.

The first portions 415 are made of the same material as the black matrix 413, and are simultaneously formed with the black matrix 413 in a same fabricating step. The second portions 416 are made of the same material as the first coating layer 412, and are simultaneously formed with the first coating layer 412 in a same fabricating step.

A second substrate 43 includes a plurality of second protrusions 434 at the non-display area thereof. Each of the second protrusions 434 includes a third portion 435, and a fourth portion 436 extending from the third portion 435. A second coating layer 432 is provided in the display area of the liquid crystal display panel 40. Further, a plurality of spacers 46 are provided in the display area of the liquid crystal display panel 40.

The third portions 435 are made of the same material as the second coating layer 432, and are simultaneously formed with the second coating layer 432 in a same fabricating step. The fourth portions 436 are made of the same material as the spacers 46, and are simultaneously formed with the spacers 46 in a same fabricating step.

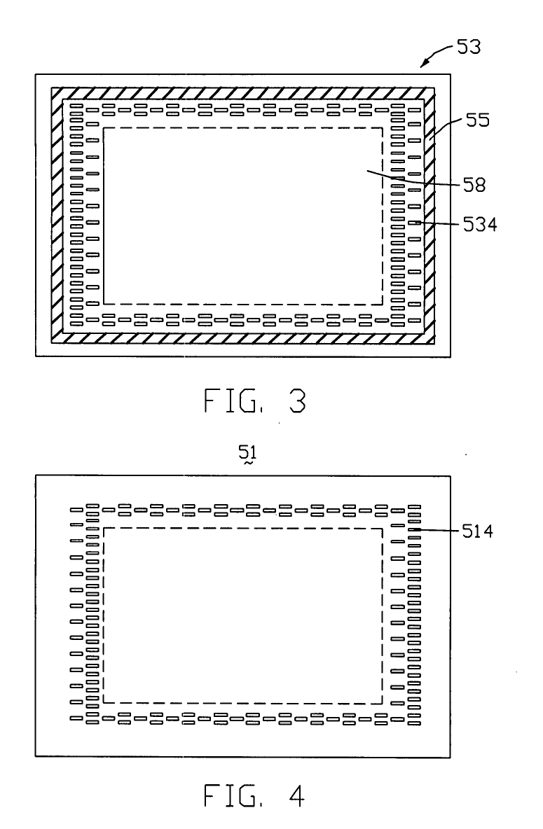

Referring to FIG. 3, this is a top plan view of a second substrate 53 of a liquid crystal display panel according to a third embodiment of the present invention. The liquid crystal display panel has a structure similar to that of the liquid crystal display panel 20. However, each three adjacent second protrusions 534 at the second substrate 53 define a protrusion unit (not labeled). The three second protrusions 534 defining the protrusion unit are generally arranged in a triangle. All the protrusion units are located between a display area 58 and a sealant 55. All the second protrusions 534 have the same size and a same uniform rectangular shape when viewed from above. Preferably, each of the second protrusions 534 has the same girth along an entire height thereof. All the triangular protrusion units have the orientation. In the illustrated embodiment, the triangular protrusion units are isosceles triangles. A base of the triangle is at the left side of each protrusion unit, and is parallel to a left side of the second substrate 53; and a point of the triangle opposite the base points toward a right side of the second substrate 53.

Referring to FIG. 4, this is a bottom plan view of a first substrate 51 of the liquid crystal display panel of the third embodiment of the present invention. The first substrate 51 includes a plurality of first protrusions 514 arranged corresponding to the second protrusions 534. Each three adjacent first protrusions 514 define a protrusion unit (not labeled). The three first protrusions 514 defining the protrusion unit are generally arranged in a triangle. However, a base of the triangle is at the right side of each protrusion unit, and is parallel to a right side of the first substrate 51; and a point of the triangle opposite the base points toward a left side of the first substrate 51. After the first substrate 51 is attached to the second substrate 53, the first and second protrusions 514, 534 are alternately located between the first and second substrates 51, 53. That is, the first and second protrusions 514, 534 are staggered relative to each other.

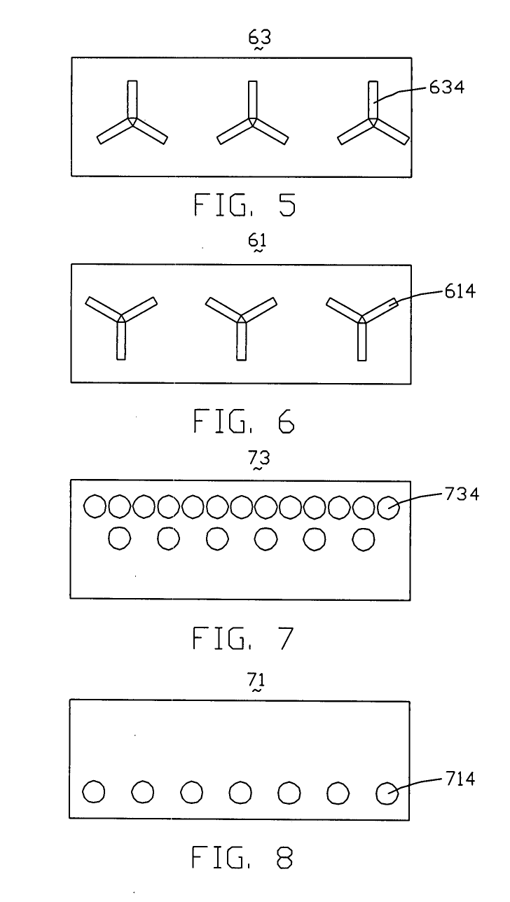

Referring to FIGS. 5 and 6, these are plan views respectively of parts of second protrusions 634 formed at a second substrate 63 and parts of first protrusions 614 formed at a first substrate 61 of a liquid crystal display panel (not labeled) according to a fourth embodiment of the present invention. The liquid crystal display panel has a structure similar to that of the liquid crystal display panel 20. However, each of the first and second protrusions 614, 634 has a 3-point star-shaped profile when viewed from above. Put another way, the profile resembles a 3-vane fan, with each vane (arm) extending from a central hub. The vanes have a same narrow uniform transverse width, and are evenly spaced apart from each other. Put yet another way, each first and second protrusion 614, 634 is generally “Y” shaped. Preferably, each of the first and second protrusions 614, 634 tapers from a base end thereof to a free end thereof. After the first substrate 61 is attached to the second substrate 63, the arms of the first protrusions 614 are alternately located relative to the arms of the second protrusions 634. That is, the first and second protrusions 614, 634 are staggered relative to each other. Various alignments and staggering arrangements can be configured, in similar ways to at least some of the alignments and staggerings described above in relation to the first, second and third embodiments.

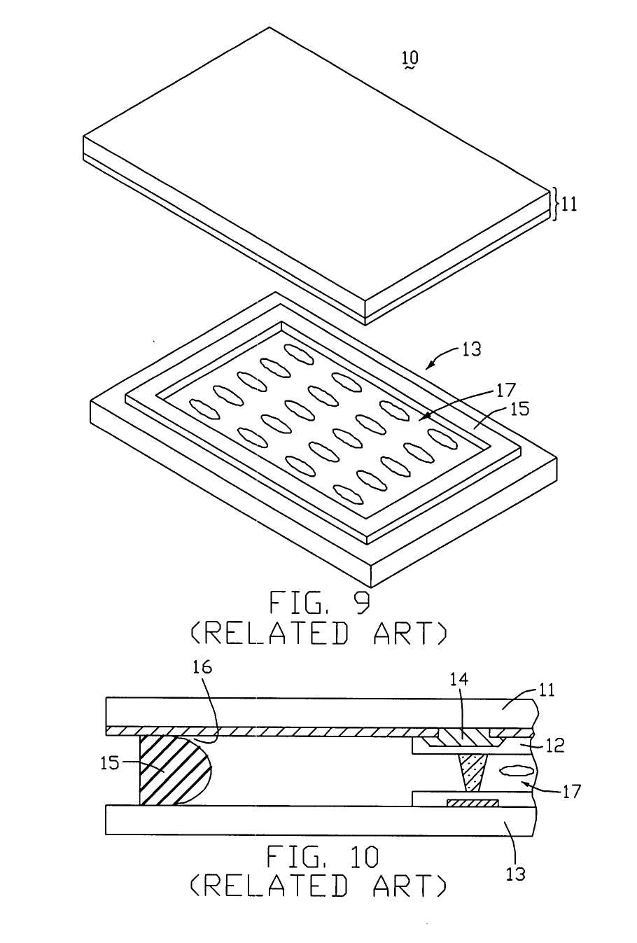

Referring to FIGS. 7 and 8, these are isometric views respectively of parts of second protrusions 734 formed at a second substrate 73 and parts of first protrusions 714 formed at a first substrate 71 of a liquid crystal display panel (not labeled) according to a fifth embodiment of the present invention. The liquid crystal display panel has a structure similar to that of the liquid crystal display panel 20. However, each of the first and second protrusions 714, 734 has a cylindrical shape. After the first substrate 71 is attached to the second substrate 73, the first protrusions 714 are alternately located relative to certain of the second protrusions 734 that are regularly spaced relatively far apart from each other. That is, the first protrusions 614 are staggered relative to said certain of the second protrusions 634.

Various modifications and alterations to the above-described embodiments are possible. For example, the protrusions at the first and second substrates may have other shapes. The protrusions at the first substrate may be made of or include the same material as a common electrode provided at the first substrate. The protrusions at the second substrate may be made of or include the same material as a gate electrodes of TFTs provided at the second substrate.

It is to be further understood that even though numerous characteristics and advantages of the present embodiments have been set out in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A liquid crystal display, comprising:
a liquid crystal display panel defining a display area, and a non-display area around the display area, the liquid crystal display panel comprising:
a first substrate;
a second substrate parallel to the first substrate;
a sealing member located at peripheral sides of the non-display area of the second substrate, the sealing member coupled with the first and second substrates defining a liquid crystal cell; and
a liquid crystal layer contained in the liquid crystal cell;
wherein the first substrate comprises a plurality of first protrusions located at the non-display area adjacent to the sealing member, the second substrate comprises a plurality of second protrusions located at the non-display area adjacent to the sealing member, the first protrusions protrude toward the second substrate, the second protrusions protrude toward the first substrate, and the first protrusions are alternately arranged relative to the second protrusions.

2. The liquid crystal display as claimed in claim 1, wherein each of the first and second protrusions has a trapezoidal cross-section.

3. The liquid crystal display as claimed in claim 2, wherein the trapezoidal cross-section is an isosceles trapezoid.

4. The liquid crystal display as claimed in claim 2, wherein a maximum width of the trapezoidal cross-section is in a range up to 200 micrometers, a minimum width of the trapezoidal cross-section is in a range down to 20 micrometers.

5. The liquid crystal display as claimed in claim 2, wherein the trapezoidal cross-section has a height varied in the range from 1.5 micrometers to 2.5 micrometers.

6. The liquid crystal display as claimed in claim 1, wherein each of the first and second protrusions is “Y” shaped.

7. The liquid crystal display as claimed in claim 1, wherein each of the first and second protrusions has a cylindrical shape.

8. The liquid crystal display as claimed in claim 1, wherein the first substrate further comprises a color filter layer at the display area and a first coating layer covering the color filter layer.

9. The liquid crystal display as claimed in claim 8, wherein the first protrusions are made of the same material as the first coating layer.

10. The liquid crystal display as claimed in claim 8, wherein the first protrusions are simultaneously formed with the black matrix in a same fabricating step.

11. The liquid crystal display as claimed in claim 7, wherein each of the first protrusions comprises a first portion, and a second portion extending from the first portion.

12. The liquid crystal display as claimed in claim 11, wherein the color filter layer comprises a plurality of color filter units and a black matrix, the black matrix fills gaps between the color filter units.

13. The liquid crystal display as claimed in claim 12, wherein the first portions of the first protrusions are made of the same material as the black matrix, the second portions are made of the same material as the first coating layer.

14. The liquid crystal display as claimed in claim 1, wherein the second substrate further comprises a plurality of thin film transistors and a second coating layer covering the thin film transistors.

15. The liquid crystal display is claimed in claim 14, wherein the second protrusions are made of the same material as the second coating layer.

16. The liquid crystal display as claimed in claim 14, wherein the second protrusions are simultaneously formed with the second coating layer in a same fabricating step.

17. The liquid crystal display as claimed in claim 1, wherein each three adjacent second protrusions define a protrusion unit, all the protrusion units have the orientation.

18. The liquid crystal display as claimed in claim 17, wherein the three first protrusions defined the protrusion unit are arranged in a triangle.

19. The liquid crystal display as claimed in claim 18, wherein the triangular protrusion units are isosceles triangles.

20. A liquid crystal display, comprising:
a liquid crystal display panel defining a display area and a non-display area around the display area, the liquid crystal display panel comprising:
a first substrate;
a second substrate disposed parallel to the first substrate;
a sealing member located at peripheral sides of the non-display area of the second substrate, the sealing member coupled with the first and second substrates defining a liquid crystal cell; and
a liquid crystal layer contained in the liquid crystal cell;
wherein the first substrate comprises a plurality of first protrusions located at the non-display area between the display area and the sealing member, the second substrate comprises a plurality of second protrusions located at the non-display area between the display area and the sealing member, each of the first protrusions protrudes toward the second substrate, each of the second protrusions protrudes toward the first substrate, and the plurality of first protrusions are staggered relative to at least a plurality of the second protrusions.
